(19) United States
(12) Patent Application Publication
(10) Pub. No.: US 2026/0340110 A1
(43) Pub. Date: Oct. 29, 2026

(54) ISOLATING APPLICATION AND SOFTWARE DEVELOPMENT KIT SANDBOXES FOR SECURITY PROTECTION

(71) Applicant: Visa International Service Association, San Francisco, CA (US)

(72) Inventor: Yuexi Chen, Foster City, CA (US)

(73) Assignee: Visa International Service Association, San Francisco, CA (US)

(21) Appl. No.: 19/099,107

(22) PCT Filed: Aug. 10, 2022
(86) PCT No.: PCT/US2022/074756

§ 371 Date: Jan. 28, 2025

(51) Int. Cl. G06F 21/53; G06F 21/62

(52) U.S. Cl. CPC G06F 21/53; G06F 21/6281

(57) ABSTRACT

Systems and methods are disclosed for application run-time architectures that provide continuous and autonomous security protection from unauthorized access to sensitive data. Several aspects comprise running, on a client device, a software development kit (SDK) in a first application sandbox with a first unique identifier (UID); and running, on the client device, an application comprising an SDK interface in a second application sandbox with a second UID, the application communicating with the SDK via the SDK interface on a runtime service. The first UID and the second UID are each associated with their own resources. The resources may include files, keys, and registries. The first application sandbox may prevent access to resources associated with the first UID by applications without the first UID. The second application sandbox may prevent access to resources associated to the second UID by applications without the second UID.

### TECHNICAL FIELD

The present technology pertains to systems and methods for ensuring the security integrity of data files and resources in computing and client devices, and preventing access of sensitive data and files by malicious actors and applications. In particular, but not by way of limitation, the present technology provides systems and methods for isolating application and software development kit (SDK) sandboxes for security protection.

### BACKGROUND

When an application integrates an integrated SDK, or otherwise, there is no sandbox separation between the primary application and the integrated SDK, because they are running in the same common application sandbox process and have the same unique identifier (UID). This means that a security vulnerability in the primary application may allow malicious actors and application to access sensitive data and processes belonging to the integrated SDK.

### SUMMARY

In various aspects the present disclosure is directed generally to a method to provide continuous and autonomous security protection from unauthorized access to privileged and sensitive system and user data in a runtime environment. The method comprises running, on a client device, an SDK in a first application sandbox with a first UID; running, on the client device, an application comprising an SDK interface in a second application sandbox with a second UID; and communicating between the application and the SDK via the SDK interface on a runtime service.

In various aspects, the first UID and the second UID may be associated with separate resources, wherein each of the separate resources includes at least one file, key, or registry or access privilege to a resource.

In various aspects, the method may comprise preventing, by the first application sandbox, access to SDK resources contained in the first application sandbox by applications without the first UID; and preventing, by the second application sandbox, access to application resources contained in the second application sandbox by applications without the second UID.

In various aspects, the method also may comprise, receiving, by the second application sandbox, an access request from the SDK, wherein the access request is transmitted by the SDK interface and permitting, by the second application sandbox, the SDK access to application resources associated with the second UID.

In various aspects, the method may comprise preventing, by an operating system, access to SDK resources associated with the first UID by requests without the first UID, and preventing by the operating system, access to application resources associated with the second UID by requests without the second UID.

In various aspects, the SDK provides at least one functionality for the application.

In various aspects, the present disclosure provides, communicating between the application and the SDK comprises transmitting instructions from the application to the SDK to execute the at least one functionality.

In various aspects, the method may comprise executing the communicating between the application and the SDK by using at least one of a data blob exchange mechanism, a call back object, or an inter process communication call.

In various aspects, the present disclosure provides a method to secure a digital environment. The method comprises assigning, by the client device, a first unique identifier (UID) to a SDK newly installed from an SDK installation package; assigning, by the client device, a second UID to an application newly installed on the client device from an application installation package, the application newly installed comprising an SDK interface; executing the application newly installed on the client device; and initiating the SDK interface in a common application sandbox containing the application newly installed on the client device and the SDK interface.

In various aspects, the method also comprises sending a request from the client device to an application distribution server to download the application; detecting a dependency between the application newly installed and the SDK installation package in the application distribution server; downloading, into the client device, an application installation package associated with the application newly installed; and downloading, into the client device, the detected SDK installation package without a separate request.

In various aspects, the method may comprise executing, on the client device, the SDK in an SDK sandbox; and communicating between the SDK and the application newly installed via the SDK interface on a runtime service.

In various aspects, the method may comprise executing the communicating between the application newly installed and the SDK by using at least one of a data blob exchange mechanism, a call back object, or an inter process communication call.

In various aspects, the method may comprise preventing, by the SDK sandbox, access to SDK resources contained in the SDK sandbox by applications without the first UID; and preventing, by the common application sandbox, access to application resources contained in the common application sandbox by applications without the second UID.

In various aspects, the present disclosure is directed to a client device for providing continuous and autonomous security protection from unauthorized access to privileged and sensitive data. The client device comprises a processor; and a computer readable medium storing instructions executable by the processor to: run, on a client device, an SDK in a first application sandbox with a first UID; run, on the client device, an application comprising an SDK interface in a second application sandbox with a second UID; and cause communication between the application and the SDK by way of the SDK interface on a runtime service.

In various aspects, the first UID and the second UID are associated with separate resources, wherein each of the separate resources includes at least one file, key, or registry.

In several aspects, the instructions executable by the processor of the client device, further comprise prevent, by the first application sandbox, access to SDK resources contained in the first application sandbox by applications without the first UID; and prevent, by the second application sandbox, access to application resources contained in the second application sandbox by applications without the second UID.

In various aspects, the instructions executable by the processor of the client device, further comprise receive, by the second application sandbox, an access request from the SDK, wherein the access request is transmitted by the SDK interface; and permit by the second application sandbox, the SDK access to application resources associated with the second UID.

In various aspects, the instructions executable by the processor of the client device may further comprise prevent, by an operating system, access to SDK resources associated with the first UID by requests without the first UID, and prevent, by the operating system, access to resources associated with the second UID by requests without the second UID.

In various aspects, the instructions to cause a communication may comprise, transmit instructions and data from the application to the SDK to execute at least one functionality.

In various aspects, the instructions to cause a communication may comprise, transmit instructions between the application and the SDK by using at least one of a data blob exchange mechanism, a call back object, or an inter process communication call.

### BRIEF DESCRIPTION OF THE DRAWINGS

In the description, for purposes of explanation and not limitation, specific details are set forth, such as particular aspects, procedures, techniques, clauses, examples, etc. to provide a thorough understanding of the present technology. However, it will be apparent to one skilled in the art that the present technology may be practiced in other manners that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The methods and systems disclosed herein have been represented where appropriate by conventional symbols in the drawings, showing only those specific details that are pertinent to understanding the aspects of the present disclosure so as not to obscure the disclosure with details that will be readily apparent to those of ordinary skill in the art having the benefit of the description herein.

FIG. 1 illustrates a relationship architecture between different applications installed or running on a client device in accordance with previous designs that separate each application and its resources in distinct sandbox processes.

FIG. 2 illustrates a relationship architecture between an application and an integrated SDK, in accordance with previous designs.

FIG. 3 illustrates challenges in security architectures running an application and an integrated SDK, in accordance with previous designs.

FIG. 4 illustrates a secure runtime execution environment that includes an application and an associated SDK, in accordance with at least one aspect of the present disclosure.

FIG. 5 illustrates a system and method to install an application and associated SDK in a secure architecture environment, in accordance with at least one aspect of the present disclosure.

FIG. 6 illustrates a secure application architecture environment, wherein an application and an associated software development kit (SDK) are running on a client device, according to at least one aspect of the present disclosure.

FIG. 7 illustrates a logic flow diagram of a method to provide continuous and autonomous security protection when running an application and an associated SDK, in accordance was at least one aspect of the present disclosure.

FIG. 8 illustrates a logic flow diagram of a method to set up and execute a secure environment, in accordance with at least one aspect of the present disclosure.

FIG. 9 is a diagrammatic representation of a system, in accordance with at least one aspect of the present disclosure.

### DETAILED DESCRIPTION

The following disclosure may provide exemplary systems, devices, and methods for isolating application and SDK sandboxes for security protection and related activities. Although reference may be made to such isolating applications in the examples provided below, aspects are not so limited. That is, the systems, methods, and apparatuses may be utilized for any suitable purpose.

Before discussing specific aspects and examples, some descriptions of terms used herein are provided below.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. An “application” may be computer code or other data stored on a computer readable medium (e.g. memory element or secure element) that may be executable by a processor to complete a task.

A “payment application” or “wallet application” may store credentials (e.g., account identifier, expiration date, card verification value (CVV), etc.) for accounts provisioned onto the user device. The account credentials may be stored in general memory on the mobile device or on a secure trusted execution environment (e.g., a secure element) of the user device. Further, in some aspects, the account credentials may be stored by a remote computer and the payment/wallet application may retrieve the credentials (or a portion thereof) from the remote computer before/during a transaction. Any number of different commands or communication protocols may be used to interface with the payment application and/or wallet application in order to obtain and use stored credentials associated with each application.

The payment application or wallet application may be configured to provide credentials to an authorized software application or module on a user device. For example, a payment application may be configured to interface with a master applet in order to provide credentials to a mobile application for a transaction. For instance, the payment application may provide a SDK or application programming interface (API) that the master wallet applet may use to interface with the payment application and/or wallet application. The payment application and/or wallet application may be configured to provide the sensitive information in encrypted form using stored encryption keys. Thus, each payment application and/or wallet application may have different commands and/or instructions for accessing the associated credentials stored by the payment/wallet application. For instance, each payment application and/or wallet application may have a different application program interface (API) with different commands, data requirements, authentication processes, etc., for interacting with other applications operating on the user device. Accordingly, a master wallet applet may include a number of different APIs, one for each of the different payment applications and/or wallet applications that the master wallet applet is configured to interface with.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some aspects, the device identifier may include a device fingerprint. The device fingerprint may an aggregation of device attributes. The device fingerprint may be generated by a SDK provided on the user device using, for example, a unique identifier assigned by the operating system, an International Mobile Station Equipment Identity (IMEI) number, operating system (OS) version, plug-in version, and the like.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications. As used herein, the term “product” may refer to one or more goods and/or services offered by a merchant.

A “merchant application” may include any application associated with a relying party to a transaction. For example, a merchant mobile application may be associated with a particular merchant or may be associated with a number of different merchants. In some aspects, the merchant mobile application may store information identifying a particular merchant server computer that is configured to provide a sales environment in which the merchant server computer is capable of processing remote transactions initiated by the merchant application. Further, the merchant mobile application may also include a general purpose browser or other software designed to interact with one or more merchant server computers. In some cases, the merchant mobile application may be installed in the general purpose memory of a user device and thus, may be susceptible to malicious attacks.

“Authentication” is a process by which the credential of an endpoint (including but not limited to applications, people, devices, process, and systems) can be verified to ensure that the endpoint is who they are declared to be.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting aspects, a message may refer to a packet (e.g., a data packet, a network packet, and/or the like) that includes data. It will be appreciated that numerous other arrangements are possible.

A “communication channel” may refer to any suitable path for communication between two or more entities, or two or more applications, or processes. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices (e.g., processors, servers, client devices, software applications, components of such, and/or the like).

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer or computing device, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

A “user” may include an individual. In some aspects, a user may be associated with one or more personal accounts and/or mobile devices. The user may also be referred to as a cardholder, account holder, or consumer.

In modern operating systems (“OS”), for example Mac OS, apple IOS, Android, Windows, or Linux, resource access (e.g., for data, files, cryptographic keys) and privileges are restricted at the application sandbox level. Each application is usually assigned one user ID (referred to herein as “UID”, “Unique Identifier”, or “Unique Identification Code”). All the resources of the application are restricted to the specific UID. The operating system (“OS”) and its OS file system enforce and facilitate such UID-based restrictions by preventing applications from accessing resources and/or privileges restricted to other applications with different UIDs.

In certain operating environments, one application may integrate another application or an SDK. An SDK may, in various instances, provide an application integrating the SDK with some or all of the functionalities of other applications, as well as access to restricted resources and data of the other applications. The integrating application may be referred to herein as a primary application. The integrated application may be referred to herein as the integrated application or third party application. When one application integrates a third party application, such as a SDK or otherwise, there is no sandbox separation between the primary application and the integrated third party application, or SDK, because the primary application and the integrated third party application are running in the same application sandbox process and are assigned the same UID.

The lack of sandbox separation between a primary application and an integrated application, such as an integrated SDK, for example, may give rise to security challenges and vulnerabilities. As the primary application and the integrated application, such as the integrated SDK, for example, are both running in a common application sandbox process with a common UID, the integrated application, such as the integrated SDK, for example, cannot isolate sensitive data, for example, from the primary application or other integrated applications, such as the integrated SDKs and vice versa.

Because the integrated application, or SDK, run in the common application sandbox with the primary application, in various instances sensitive data belonging or called by the SDK may be inadvertently shared with the primary application, the resource container of the primary application in the operating system's file system, or even other processes or applications within the common application sandbox, including malicious or insecure applications or processes running in the common application sandbox. The current architecture may therefore lead to unintended backdoor access to secure environments designed for transactions, payments, and other sensitive activities intended to be solely accessed by the SDK or the integrated application.

One example giving rise to security challenges and vulnerabilities is in application development or execution, like a banking application with secure payment features that are integrated as an SDK into a merchant application. A non-limiting example could include a merchant application that integrates a payment processing provider SDK. In such integration, the merchant application allows the purchase of retail goods through its application and provides a user interface (“UI”) for users to conduct transactions and making purchases. The merchant application may integrate the payment processing SDK which allows it to interact with payment networks and conduct transactions using the user's or customer's payment credentials when making purchases on the merchant application. Even if the merchant application merely implements a user interface for payment and payment processing, the payment processing SDK implements secure features such as sensitive data, cryptographic keys, payment identifiers, etc., and is unable to isolate or protect itself from the merchant application, as both are running in a common sandbox process with the same UID.

Issues associated with the failure to isolate the integrated application, or integrated SDK, from the primary application, while sharing a sandbox process and a UID, are compounded by the constant requirement to upgrade the security of integrated applications, services, and SDKs in current architectures to ensure against security vulnerabilities that may be introduced by the primary applications. The payment processing SDK, for example, may be designed and implemented to protect itself and its assets from attacks that originate from outside the common application sandbox it shares with the primary application. Primary applications that are updated or coded to provide new functionalities that are not designed with advanced security measures may become vulnerable as a result of these new functionalities or updates. For example, the new functionalities or updates may introduce vulnerabilities that may be exploited by malicious applications or actors. In turn, malicious applications or actors may hijack or exploit the vulnerabilities of the integrated application, or SDK, because of the shared sandbox process and UID. Moreover, if an application provides an SDK for integration into numerous (e.g., thousands or more) primary applications, for example an integrated payment processing SDK that facilitates payment transactions, the developers of the integrated payment processing SDK must keep track of vulnerabilities in each of these numerous primary applications to ensure that any updates or changes to the primary applications do not create security threats to the integrated payment processing SDK. The process of constant monitoring and updating the integrated payment processing SDK based on the numerous primary applications is not scalable, or practicable. This is especially problematic because poor software design is common and regularly introduces vulnerabilities into the primary applications. These vulnerabilities introduced by the primary applications then allow external attackers to gain access inside the common application sandbox to restricted resources and sensitive data of the integrated payment processing SDK.

The solutions presented herein aim to improve the security architecture of current systems, while providing communication systems and methods to facilitate the use of third party applications and SDKs that provide functionalities to primary applications. In various aspects, the present disclosure provides systems and methods to isolate the sandbox of the integrated application or SDK from the sandbox of the primary application, so that vulnerabilities in the primary application do not impact the integrated application, or SDK, and consequently reduce, or eliminate, frequent security evaluations by developers of the integrated application or SDK, to allow a quicker time to market for thousands of primary applications that integrate third party applications or SDKs. The disclosure also presents aspects where each of the primary application and the integrated application, or SDK, are executed in separate sandbox processes, each of which having a distinct UID.

In various aspects, the present disclosure provides a new and secure architecture system to ensure sensitive data of a primary application and an integrated application or SDK are separated and linked to separate UIDs. A communication interface and methods allow communication between the separated SDK and the primary application. The communication interface and methods provide the same functionality of an integrated application or SDK without any of the security vulnerabilities that arise from sharing a common sandbox process.

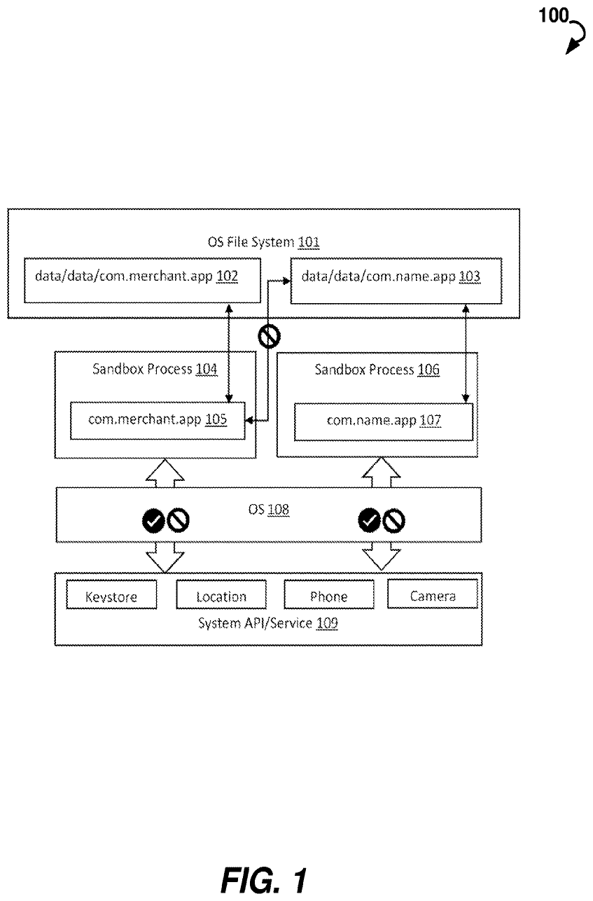

FIG. 1 illustrates a relationship architecture 100 between different applications installed or running on a client device in accordance with previous designs that separate each application and its resources in distinct sandbox processes. The architecture 100 may be run or implemented on several types of devices, including a client device, computing device, or user device. The architecture 100 includes an operating system file system 101, which may hold various data and resources of various applications that may be run by an operating system. Generally different applications are run in different sandboxes. For example, the merchant application 105 is run in one sandbox process 104, and the payment processor application 107 is run in another sandbox process 106 to ensure complete separation between the applications, their resources and their processes, and to protect each application, its processes, and resources from interference by other applications.

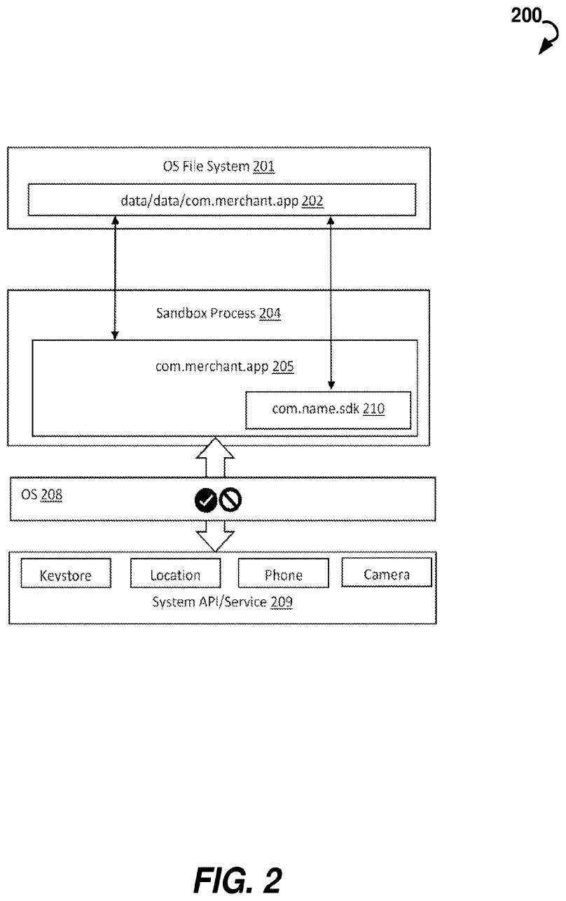

By separating the application 107 and the merchant application 105, each application is assigned a separate and distinct UID at install time which is then assigned or adopted by the sandbox process of each application. The operating system 108 also facilitates and enforces security configurations and permissions granted to each application by a client device to system APIs and services 109, which may include, but are not limited to, a client device keystore, location access and permissions, phone access, camera access, or access to any other client device service, or system API to enable access to any component and related services in the device. For example, a merchant application 105 may be granted access to the camera enforced by the OS 108 while other applications may not. In such example, the operating system 108 would allow access to the camera of the client device when such access is requested by merchant application 105, and deny it when requested by another application 107. Of course the operating system 108 may facilitate and enforce a whole range and number of different security configurations and permissions to the system API and services as desired. This separation and sandboxing of different applications means that one application cannot control or make use of the functionality of the other, especially because each application is within its own application sandbox, and resources belonging to each application are accessible only by applications with the specific UID assigned to that resource. Of course these applications: (1) are completely distinct and are not in any way linked or associated with each other, (2) cannot make use of the services and the functionalities of each other, and (3) operate independently. This design architecture 100, however, does not facilitate the use of functionality or resources of different application by one primary application. For example, the merchant application 105 cannot call or use functions of the other application 107 because they are each run in separate sandboxes. Therefore, in current systems, if an application tries to call functions or use resources associated to other applications, it must integrate SDKs into the primary application, such as the merchant application 105, for example, as illustrated and described below in FIG. 2.

FIG. 2 illustrates a relationship architecture 200 between an application and an integrated SDK, in accordance with previous designs. The architecture 200 may be run or implemented on a client device, computing device, or user device. To overcome the shortcomings of the architecture 100 shown in FIG. 1, the architecture 200 shown in FIG. 2 allows one application to utilize functions and resources that are associated with other applications, at least in a limited scope, by integrating an SDK into a primary application, wherein the SDK provides the primary application functionalities that it would not otherwise have. The SDK is generally prebuilt and provided by developers to allow other applications to incorporate prebuilt SDK packages into their applications, for example a merchant application 205, and use functions and resources that would not otherwise be accessible to the application. The architecture 200 may include an OS file system 201 that may hold resources or files that belong to an application 205 that is running on the operating system 208. The application 205 may be, for example, a merchant application.

SDKs may amongst many other things include libraries, documentation, files, processes, and built-in executables. An SDK 210, for example, may present and provide access to many of the functionalities, links to resources, data, and files of another application, for example, the application 207 presented in FIG. 2, but in a more limited scope, based on the specific design of the SDK. With reference back to FIG. 2, the SDK 210 thus may be integrated into and executed/initiated by the merchant application 205 to directly provide many of the functionalities that could be provided by the native application 207, even when the SDK 210 is in a common application sandbox process 204 that has a different UID to that of the application 207. The SDK 210 itself possesses many access permissions to databases and resources of the native application 207. The OS 208 will permit or enforce access to system APIs and services 209. The OS 208 also facilitates and enforces security configurations and permissions granted to each application by a client device to system APIs and services 209, which may include, but are not limited to, a client device keystore, location access and permissions, phone access, camera access, or access to any other client device service, or system API to enable access to any component and related services in the device.

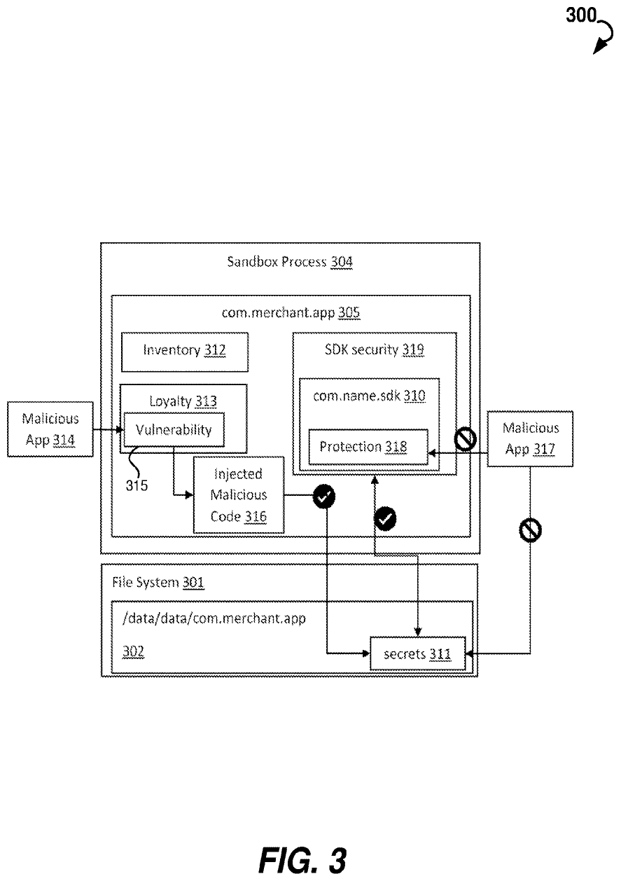

FIG. 3 illustrates challenges in the security architectures running an application and an integrated SDK, in accordance with previous designs, for example as described in FIG. 3. The architecture 300 may be run or implemented on several types of devices, including a client device, computing device, or user device. The architecture 300 may include an application 305, such as a merchant application running in a sandbox process 304 environment that separates the merchant application from other applications (e.g., malicious applications 314, 317). The application 305 may include various modules that may implement functionalities, services, or provide user interfaces, such as an inventory module 312 or a loyalty module 313.

Generally, applications may be updated over time with changes to existing modules or the addition of new modules. Similar to FIG. 1-2, the OS file system 301 may include resources 302 in a container in file system 301 that may include information or sensitive data 311, and may prevent or allow access to resources 302 based on where an access request is received from. When access requests are received from applications with a different UID to application UID of the application 305, then access to the resources 302 is denied. Sensitive information may include passwords, user information, data from the client or user device and the like. The architecture 300 may utilize security measures 320 that protect the SDK 310 from unauthorized access from malicious applications such as a malicious app 317 and ensure that the SDK does not provide vulnerabilities to the application 305. The security measures 319 may include security modules 318 running on or as part of the SDK 310. However, even with the security measures 319, the SDK 310 and the application running both in the same sandbox process 304 container, and having the same UID have access to the same resources 302 on the file system 301. This means that both the application 305 and the SDK 310 will be able to transmit and receive information to and from the resources container 302 and the sensitive data 311. The resource container 302 and the sensitive data 311 also may access the SDK's 310 functions and data when these are needed by the application 305 such requests are allowed since the resource container 302 is accessible by all applications or modules with the UID of the application 305.

One shortcoming of the architecture 300 illustrated in FIG. 3 is that the SDK 310 is incorporated as part of the application 305, and therefore may be susceptible to security flaws of the application 305. For example, if the application 305 contains no vulnerabilities, but makes an update or change to the code for the loyalty module 313, for example to change how the loyalty module 313 appears on the user interface of the application, a security flaw or vulnerability 315 can be introduced into the module 313 if this update or change to the code is carried out poorly. This flaw or vulnerability 315 then becomes a target for attack vectors from malicious applications, such as the malicious app 314. The malicious app 314 may exploit the vulnerability 315, for example, by injecting malicious code 316 into the module 313 of the application 305. The malicious code 316 may subsequently attempt to access the sensitive data 311 that is stored in the merchant app resources 302. Because the malicious code 316 is interfacing with the file system 301, and/or the OS 308 through the application 305, the malicious code 316 is interfacing with the file system 301 and/or the OS 308 as the application 305 with the UID of the application 305, and therefore is able to access the resources 302 and sensitive data 311. Because the malicious code 316 shares the same UID as the application 305, the malicious code 316 access requests will be authorized by the file system 301. Furthermore, the ability to interact with the resources 302 and the sensitive data 311, means that even if the malicious code 316 cannot directly access the processes of the SDK 310 due to deployed security measures 319, the processes of the SDK 310 remain vulnerable to the malicious code 316 for indirect access because the application 305 and the SDK 310 share the same UID, and are running in a common sandbox process 304.

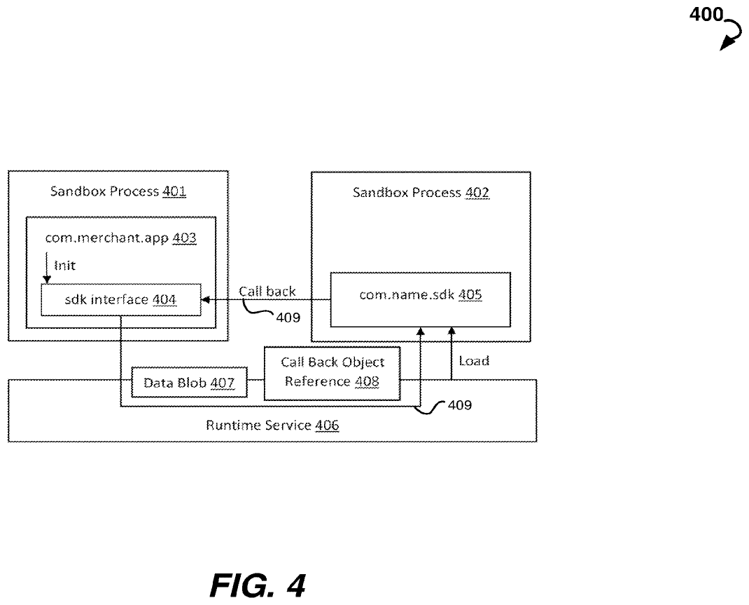

FIG. 4 illustrates a secure runtime execution environment 400 that includes an application and an associated SDK, in accordance with at least one aspect of the present disclosure. The runtime execution environment 400 may be carried out on any client device, computing device, or user device, and includes an SDK 405 running in its sandbox process 402 isolating the SDK 405 from interactions from outside of the sandbox process 402 without a first UID associated with the sandbox process 402. The runtime execution environment 400 also includes an application 403 that runs in a sandbox process 401 with a second UID, different than the first UID. An SDK interface 404 also runs in the sandbox process 401. The SDK interface 404 provides communication pathway 409 between the application 403 and the SDK 405. In various aspects the SDK interface 404 may be an interface API(s) defined by the SDK developer and only exposed to the SDK 405. In several aspects, the SDK interface 404 has defined input, from the application 403 to SDK 405 and output, from SDK 405 to application 403. The application 403 only access to the exposed SDK interface 404 API, it has no access to SDK 405 resources.

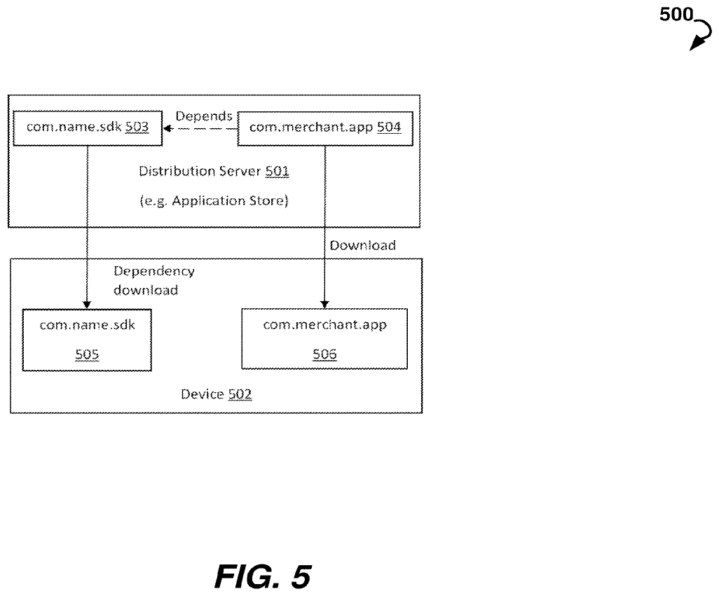

In various aspects, the application 403 is a merchant application, and the SDK 405 is associated with a payment processing network, and is configured to facilitate various payment functionalities such as undertaking payment transactions via the application 403. The application 403 may be or may include a user interface for customers to conduct transactions with the merchant, relying on the functionalities of the SDK 405 to process the transaction. The application 403 when executed may initiate the SDK interface 404, which runs in the same sandbox process 401 as the application 403. A runtime service 406, or another communication channel, executed on the client device 502, FIG. 5, may facilitate communication between the two application sandbox processes 401 and 402, and in particular communication between the merchant application 403 and the SDK 405 by way of the SDK interface 404.

During the execution of runtime service 406, or another communication channel, the SDK interface 404 can exchange data blobs 407 or call back object references 408 to the SDK 405. The SDK 405 based on the exchanged data blobs 407 and/or the call back object references 408 will carry out functionalities it is programmed to undertake. In at least one example, such functionalities may include accessing client accounts or undertaking transactions via payment processing systems. The runtime service 406, or another communication channel, is able to load the instructions in the form of data blobs 407 and call back object references 408 into the SDK 405. The SDK 405 is able to call back on the application 403 through the SDK interface 404 and request information, data, or the undertaking of actions or specific functions. he runtime service 406, or another communication channel, may load the SDK 405 and then send data to the SDK 405 in one non-limiting example as follows:

SystemRuntimeService.loadSDK(“com.paymentnetwork.sdk”,
_SdkCallbackInstance, _HostApplicationInstance); and
SystemRuntimeService.sendData(“com.paymentprocessor.sdk”,
_datablob).

FIG. 5 illustrates of systems and methods to install an application and associated SDK into a secure architecture environment, in accordance with at least one aspect of the present disclosure. The system 500 includes a distribution server 501 (e.g., an application store) that contains an application 504, for example a merchant application, with a dependency to an SDK 503, for example a visa SDK. The application 504 and the SDK 503 may refer to binary packages stored in the distribution server 501, which are for download and installation into a client device. A client device 502 downloads the application 504 as a binary installation package, which may trigger a dependency download of the SDK 503 as its own distinct binary installation package into the client device 502. The downloaded binary packages of the application 504 and the SDK 503 are then installed, and are assigned different UIDs at install. This architecture allows the application 506 and the SDK 505 to run in separate sandbox processes on the client device 502.

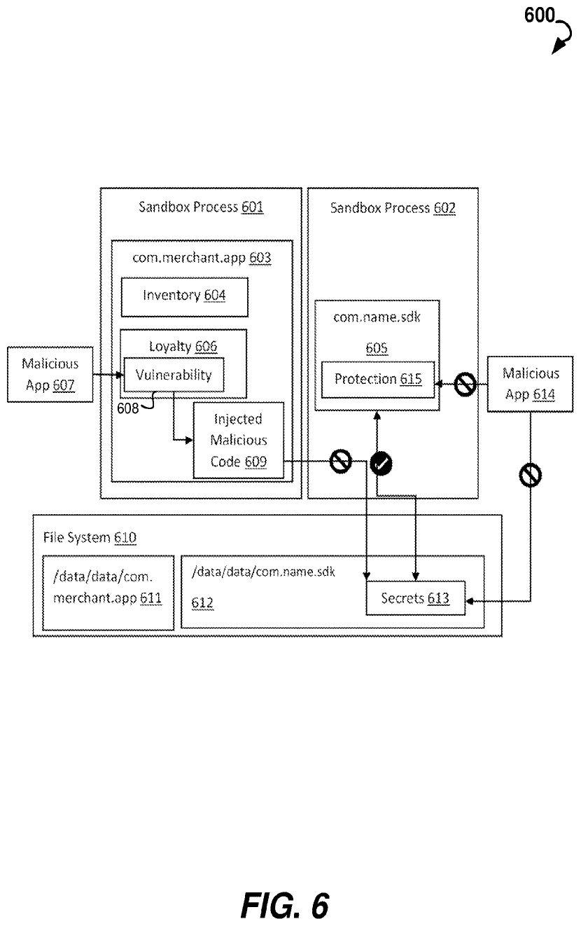

Turning now to the figures, FIG. 6 illustrates a secure application architecture environment 100, wherein an application and an associated SDK are running on a client device 502, FIG. 5, according to at least one aspect of the present disclosure. The architecture environment 600 may be run or implemented on several types of devices, including the client device 502, FIG. 5, computing device, or user device. The architecture environment 600 includes a primary application 603 (also referred to herein as “application 603”) that is executed inside an application sandbox process, such as a first sandbox process 601 (also referred to herein as “application sandbox”, “sandbox process”, or “sandbox”). The application 603 is assigned a UID (referred to hereinafter as “application UID”). The application UID is assigned/applied to, or adopted by, the first sandbox process 601. The application 603 may be a merchant application, and may include an inventory module 604, which may include information and data on the inventory available for sale by the merchant. The application 603 also may include sensitive user or merchant files, data, or information (collectively referred to hereinafter as “resources” or “application resources”).

On the same device, an SDK 605, is assigned its own distinct UID (referred to hereinafter as “SDK UID”). The SDK 605 also runs or is executed to run within a second sandbox process 602. The second sandbox process 602 is assigned or adopts the SDK UID that is distinct and different from the UID for the first sandbox process 601. The application 603 has access to merchant data and resources 611 that are associated with the application UID. Meanwhile, the SDK 605 has access to resources 612 that are assigned or are associated with the SDK UID, associated with the second sandbox process 602. The resources 611, 612 each may be contained in separate and distinct containers in the OS file system 610. The UIDs for each of the application 603 (application UID) and the SDK 605 (SDK UID) are assigned at installation time, and may be assigned to all files and resources within the installation or binary package being installed. The different UIDs between the first and second sandbox processes 601, 602 prevent access to any processes or data falling within each sandbox process from other sandbox processes. For example, the first sandbox process 601 does not allow access to processes or resources within the first sandbox process 601 by any application with a different UID than that of the first sandbox process 601, i.e., the application UID, including applications within the second sandbox process 602, even if the SDK 605 within the second sandbox process 602 is associated, or runs concurrently, with the application 603.

Furthermore, the OS, or its file system 610, prevents access to the resources 611, 612 by any other application with a different UID to those UIDs associated with the respective resources 611, 612. In one aspect of the disclosed secure architecture environment, a malicious application 607 may attempt to, or infiltrate or inject a malicious code 609 via a vulnerability 608 into a module or an unsecured applet, newly implemented feature, or module 606. If the injected malicious code 609 attempts to access resources 612 belonging to the SDK 605, it would not be able to do so, because the malicious code 609 is operating from first sandbox process 601, which has a UID different to the common UID shared by SDK 605, the second sandbox process 602, and their associated resources 612. The operating system and in turn its file system 110 would prevent access to a resource container 112 that is associated with one UID, from a process or application running from a sandbox process associated with another UID. Furthermore, a separate malicious app 614 in a separate attempt to access resources inside the second sandbox process 602 is also unable to directly try to access any sensitive data 613 within the resources 612 or any protected data 615 within the SDK 605 because the malicious application 114 also does not have a matching UID to the SDK UID of the second sandbox process 602 and the SDK 605. Therefore, the architecture according to one aspect of the present disclosure is able to prevent malicious applications or actors from accessing sensitive information related to an SDK that is run concurrently or alongside an application such as a merchant application.

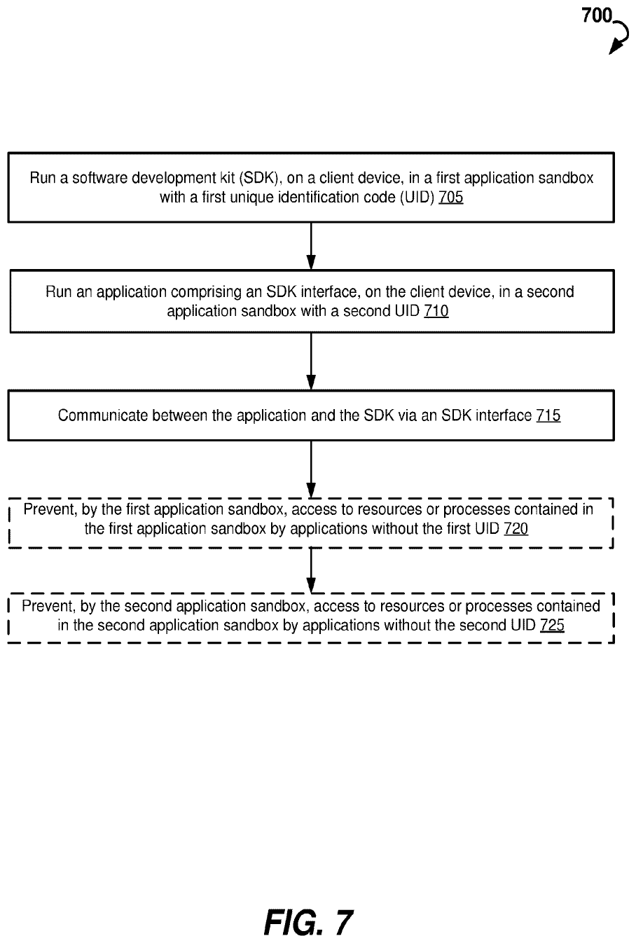

FIG. 7 illustrates a logic flow diagram of a method 700 to provide continuous and autonomous security protection when running an application and an associated SDK, in accordance was at least one aspect of the present disclosure. With reference now to FIG. 7 and FIG. 5, in accordance with the method 700, a client device 502, FIG. 5 runs 705 an SDK in its own distinct and separate sandbox with a first UID. The client device 502, FIG. 5 runs 710 an application in a second and separate application sandbox with a second UID different than the first UID.

In the example illustrated by the method 700 of FIG. 7, the second application sandbox is run with both the application and the SDK interface contained therein. The SDK interface and the application share the second UID. Meanwhile, the first UID is uniquely assigned to the SDK in the first application sandbox. As a result, direct interaction between the application and the SDK is prevented. Instead, the application communicates 715 with the SDK by way of the SDK interface.

Communications between the application and the SDK may include sending and receiving instructions, data, and information by the application to the SDK and vice versa, including but not limited to instructions to cause the SDK to carry out a functionality requested by the application or a user of the application, receiving instructions, updated information, responses to requests, or independent requests for functions and processes from the SDK to the application and vice versa, and causing the execution of processes of data retrieval by the application for a requesting SDK and vice versa. The SDK may be associated with the application, in some instances exclusively. The communications may include receiving, by the first application sandbox containing the SDK at least one access request from the application, to resources or processes associated with the first UID, alternatively, the communications may include receiving by the second application sandbox containing the application, an access request to resources or processes with the second UID, wherein the at least one access request results from the communicating or transmissions via the SDK interface, including in various aspects over a dedicated runtime service. The communications also may include permitting by the OS, or any of the applications, processes, resources, or containers receiving the request, including the application, SDK, SDK interface, and/or the relevant sandbox access to the resources being requested.

In the example illustrated in FIG. 7, in accordance with the method 700, may include an optional step where the first application sandbox prevents 520 access to the SDK, its data, contents, processes, and/or to resources related to the SDK by any application without the first UID. A subsequent optional step may be included where the second application sandbox prevents 725 access to the application, its contents, processes, resources and the SDK interface without the second UID, with an exception of communications 715 transmitted by the SDK interface. Accordingly, the SDK interface facilitates a bypass of the UID access requirement of the second application sandbox, thereby facilitating an indirect communication 715 between the application and the SDK through the SDK interface.

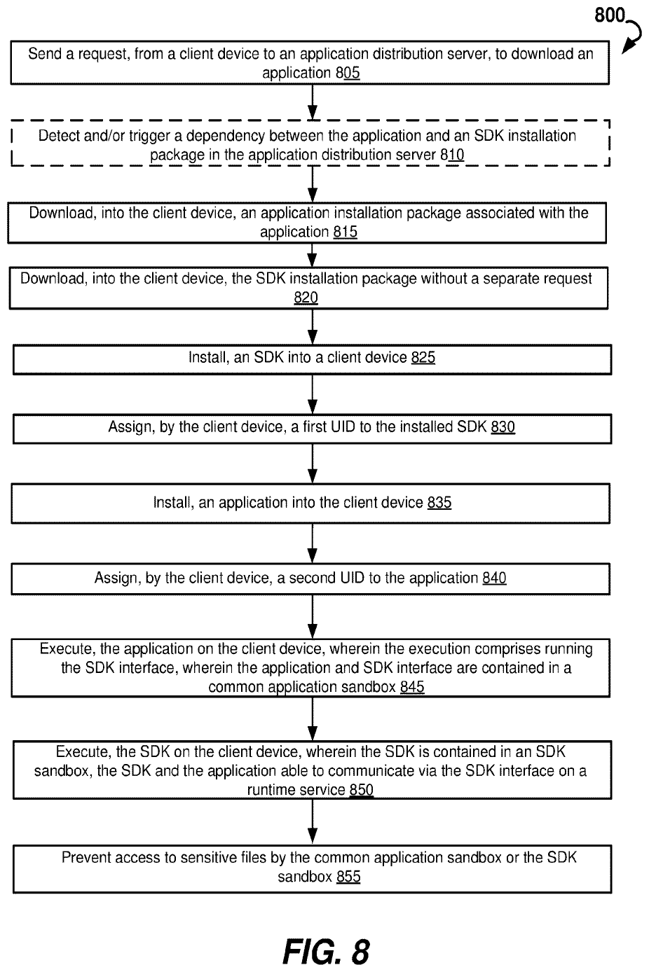

FIG. 8 illustrates a logic flow diagram of a method 600 to set up and execute a secure environment, in accordance with at least one aspect of the disclosure herein. With reference now to FIG. 5 and FIG. 8, according to the method 800, a client device 502, FIG. 5 sends 805 a request to an application distribution server 501, FIG. 5 to download an application. A device 502, FIG. 5 detects 810 and/or triggers a dependency between the application and an SDK installation package in the application distribution server 501, FIG. 5.

As described in greater detail below, the application installation package includes an SDK interface for communication with an SDK installed separately by SDK installation package. In various instances, the SDK interface uniquely facilitates a communication between the application and the SDK without a common UID.

According to the method 800, the client device. 502, FIG. 5 downloads 815 the application installation package, and the client device 502, FIG. 5 downloads 820 the SDK installation package without a separate request for download of the SDK installation package. As described in greater detail below, a dependency can trigger an automatic download 820 of the SDK installation package based on the download 815, or request for download, of the application installation package.

According to the method 800, the client device 502, FIG. 5, installs 825 an SDK, and the client device 502, FIG. 5 assigns 830 a first UID to the SDK. In addition, according to the method 800, the client device 502, FIG. 5 also installs 835 the application, and the client device 502, FIG. 5 assigns 840 a second UID to the application, different than the first UID.

Typically, in application distribution servers 501, FIG. 5, applications and any associated SDKs are provided in a unified binary package, which when downloaded and installed onto the client device 502, FIG. 5 share the same UID and application sandbox process. In various aspects of the disclosure, the binary package of the SDK and the binary package of the application are separate from one another, and remain separate in the application distribution servers. Nonetheless, the separate binary packages of the SDK and the application may still be dependent upon one another, have dependencies that link them to each other, or otherwise be associated with each other on the application distribution server 501, FIG. 5. In accordance with this arrangement, when the client device 502, FIG. 5 sends 805 a request from the client device 502, FIG. 5 to an application distribution server 502, FIG. 5 to download an application, from the application distribution server 501, FIG. 5 such as an application marketplace (e.g., apple app store, or the android app store), the request may trigger the dependency between the application binary package requested and the SDK binary package.

In the example of the method 800 illustrated in FIG. 8, the application binary package does not contain the SDK but contains an SDK interface. Because the binary package of the application and the binary package of the SDK are separate from one another, but are associated in the marketplace, a download of one, or a request made to the application market place to download one, triggers the other to be separately downloaded based on the dependency that exists therebetween. In at least one example, when one is downloaded or a request to download one is sent to the application marketplace, the dependency that exists between them causes the other to also be downloaded separately into the client device 502, FIG. 5.

In various aspects, the application distribution server 501, FIG. 5 detects 810 the dependency when the request is sent to and/or received by the application distribution server 501, FIG. 5. In other aspects, the dependency is automatically triggered once the request to the application distribution server 501, FIG. 5 is sent and/or received. In several aspects, the application distribution server 501, FIG. 5 will check dependencies of the application requested to be downloaded, and then determines or detects that a dependency exists between an SDK and the requested application. In many aspects the dependency exists in the SDK and/or the application binary packages, and the dependencies may be designed for one or more application distribution servers 501, FIG. 5 or application marketplaces, so that when one of the application or SDK is downloaded, the other dependency linked binary packages is downloaded. Alternatively, the distribution server 501, FIG. 5 detects and/or enables download of both the application and SDK.

The application binary package, containing the SDK interface and the application is then downloaded 815 into the client device 502, FIG. 5, and the SDK installation package is also downloaded 820 into the client device 502, FIG. 5. The SDK is installed 825 into the client device 502, FIG. 5 from its downloaded binary package, and the operating system or the client device 502, FIG. 5 assigns a first UID to the installed SDK. The application is also installed 835 along with the SDK interface from its binary package and the operating system or the client device 502, FIG. 5 assigns another UID common to both the installed application and the SDK interface. When the application is run or executed 845 on the client device 502, FIG. 5, in certain aspects, the SDK is also executed 850 on the client device 502, FIG. 5. However, each of the SDK and the application is executed in their own unique and distinct sandbox process environments with their respective UIDs. The SDK interface, installed with the application, runs in the sandbox process of the installed application, and is used as an interface for communication between the application and the installed SDK running in the separate sandbox process. In the foregoing architecture, each of the SDK sandbox and the common application sandbox prevents unauthorized access 855 to the contents of the respective sandboxes and only allow communication to each other via the SDK interface in the common application sandbox.

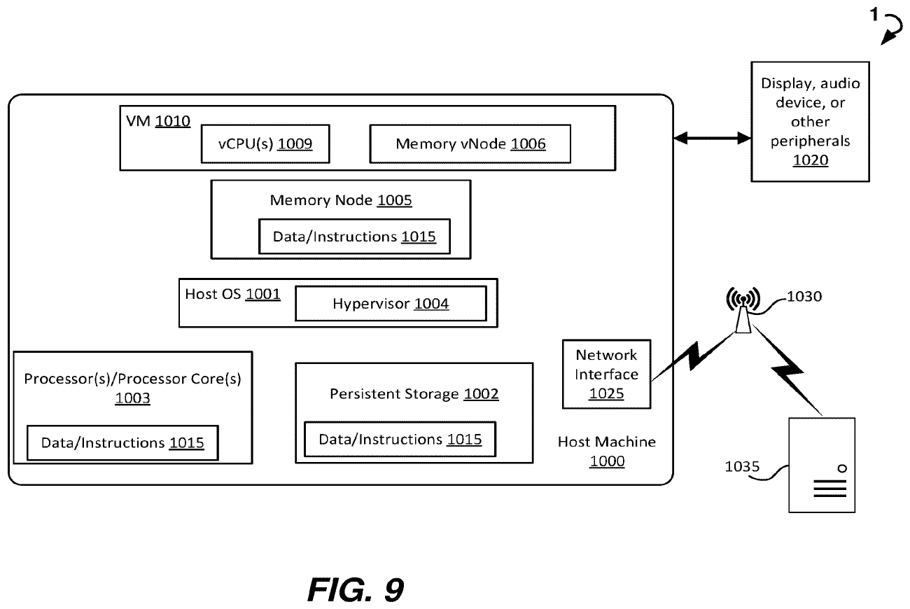

FIG. 9 is a diagrammatic representation of a system 1, in accordance with at least one aspect of the present disclosure. The system 1 includes a host machine 1000, within which a set of instructions for causing the host machine 1000 to perform any one or more of the methods, or portions of the methods, described by the present disclosure may be executed. In various example aspects, the host machine 1000 operates as a standalone device or may be connected (e.g., networked) to other machines. In a networked deployment, the host machine 1000 may operate in the capacity of a server or a client machine in a server-client network environment, or as a peer machine in a peer-to-peer (or distributed) network environment. The host machine 1000 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 1 includes the host machine 1000, running a host operating system (OS) 1001 on a processor or multiple processor(s)/processor core(s) 1003 (e.g., a central processing unit (CPU), a graphics processing unit (GPU), or both), and various memory nodes 1005. Host OS 1001 may include a hypervisor 1004 which is able to control the functions and/or communicate with a virtual machine (“VM”) 1010 running on machine readable media. VM 1010 may also include a virtual CPU or vCPU 1009. Memory nodes 1005, and 1007 may be linked or pinned to virtual memory nodes or vNodes 1006 respectively. When a memory node 1005 is linked or pinned to a corresponding virtual node 3006, then data may be mapped directly from the memory nodes 1005 to their corresponding vNodes 1006.

All the various components shown in host machine 1000 may be connected with and to each other, or communicate to each other via a bus (not shown) or via other coupling or communication channels or mechanisms. The host machine 1000 may further include a video display, audio device or other peripherals 1020 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 1002 (also referred to as disk drive unit), and a network interface device 1025. The host machine 1000 may further include a data encryption module (not shown) to encrypt data.

The components provided in the host machine 1000 are those typically found in computer systems that may be suitable for use with aspects of the present disclosure and are intended to represent a broad category of such computer components that are known in the art. Thus, the system 1 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 1002 may also be a Solid-state Drive (SSD), a hard disk drive (HDD), e.MMC, UFS, or other computer or machine-readable medium on which is stored one or more sets of instructions and data structures (e.g., data or instructions 1015) embodying or utilizing any one or more of the methodologies or functions described herein. The instructions 1015 may also reside, completely or at least partially, within the main memory node 1005 and/or within the processor(s) 1003 during execution thereof by the host machine 1000. The processor(s) 1003, and memory nodes 1005 may also comprise machine-readable media.

The instructions 1015 may further be transmitted or received over a network 1030 via the network interface device 1025 utilizing any one of several well-known transfer protocols (e.g., Hyper Text Transfer Protocol (HTTP)). The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine 1000 and that causes the machine 1000 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the aspects of the disclosure as described herein.

The computer program instructions may also be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 1000, with each server 1035 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.
Clause 1. A method to provide continuous and autonomous security protection from unauthorized access to privileged and sensitive system and user data in a runtime environment, the method comprising running, on a client device, a software development kit (SDK) in a first application sandbox with a first unique identifier (UID); running, on a client device, an application comprising an SDK interface in a second application sandbox with a second UID; and communicating between the application and the SDK via the SDK interface on a runtime service.
Clause 2. The method of Clause 1, wherein the first UID and the second UID are associated with separate resources, wherein each of the separate resources includes at least one file, key, or registry.
Clause 3. The method of any one of Clauses 1-2, further comprising preventing, by the first application sandbox, access to SDK resources contained in the first application sandbox by applications without the first UID; and preventing, by the second application sandbox, access to application resources contained in the second application sandbox by applications without the second UID.
Clause 4. The method of any one of Clauses 1-3, further comprising receiving, by the second application sandbox, an access request from the SDK, wherein the access request is transmitted by the SDK interface; and permitting, by the second application sandbox, the SDK access to application resources associated with the second UID.
Clause 5. The method of any one of Clauses 1-4, further comprising preventing, by an operating system, access to SDK resources associated with the first UID by requests without the first UID; and preventing, by the operating system, access to application resources associated with the second UID by requests without the second UID.
Clause 6. The method of any one of Clauses 1-5, wherein the SDK provides at least one functionality for the application.
Clause 7. The method of any one of clauses 1-6, wherein the communicating between the application and the SDK comprises transmitting instructions from the application to the SDK to execute the at least one functionality.
Clause 8. The method of any one of Clauses 1-7, further comprising executing the communicating between the application and the SDK by using at least one of a data blob exchange mechanism, a call back object, or an inter process communication call.
Clause 9. A method to secure a digital environment in a client device, the method comprising assigning, by the client device, a first unique identifier (UID) to a software development kit (SDK) newly installed from an SDK installation package; assigning, by the client device, a second UID to an application newly installed on the client device from an application installation package, the application comprising an SDK interface; executing the application newly installed on the client device; and initiating the SDK interface in a common application sandbox containing the application newly installed on the client device and the SDK interface.
Clause 10. The method of Clause 9, further comprising sending a request from the client device to an application distribution server, to download the application; detecting a dependency between the application and the SDK installation package in the application distribution server; downloading, into the client device, an application installation package associated with the application; and downloading, into the client device, the detected SDK installation package without a separate request.
Clause 11. The method of any one of Clauses 9-10, further comprising executing, on the client device, the SDK in an SDK sandbox; and communicating between the SDK and the application via the SDK interface on a runtime service.
Clause 12. The method of any one of Clauses 9-11, further comprising executing the communicating between the application and the SDK by using at least one of a data blob exchange mechanism, a call back object, or an inter process communication call.
Clause 13. The method of any one of Clauses 9-13, further comprising preventing, by the SDK sandbox, access to SDK resources contained in the SDK sandbox by applications without the first UID; and preventing, by the common application sandbox, access to application resources contained in the common application sandbox by applications without the second UID.
Clause 14. A client device for providing continuous and autonomous security protection from unauthorized access to privileged and sensitive data, the client device comprising a processor; and a computer readable medium storing instructions executable by the processor to run, on a client device, a software development kit (SDK) in a first application sandbox with a first unique identifier (UID); run, on the client device, an application comprising an SDK interface in a second application sandbox with a second UID; and cause a communication between the application and the SDK by way of the SDK interface on a runtime service.
Clause 15. The client device of Clause 14, wherein the first UID and the second UID are associated with separate resources, wherein each of the separate resources includes at least one file, key, or registry.
Clause 16. The client device of any one of Clauses 14-15, wherein the instructions executable by the processor, further comprise prevent, by the first application sandbox, access to SDK resources contained in the first application sandbox by applications without the first UID; and prevent, by the second application sandbox, access to application resources contained in the second application sandbox by applications without the second UID.
Clause 17. The client device of any one of Clauses 14-16, wherein the instructions executable by the processor, further comprise receive, by the second application sandbox, an access request from the SDK, wherein the access request is transmitted by the SDK interface; and permit, by the second application sandbox, the SDK access to application resources associated with the second UID.
Clause 18. The client device of any one of Clauses 14-17, wherein the instructions executable by the processor, further comprise prevent, by an operating system, access to SDK resources associated with the first UID by requests without the first UID; and prevent, by the operating system, access to SDK resources associated with the second UID by requests without the second UID.
Clause 19. The client device of any one of Clauses 14-18, wherein the instructions to cause a communication, comprise transmit instructions from the application to the SDK to execute at least one functionality.
Clause 20. The client device of any one of Clauses 14-19, wherein the instructions to cause a communication, comprise transmit instructions between the application and the SDK by using a data blob exchange mechanism, a call back object, or an inter process communication call.

The foregoing detailed description includes references to the accompanying drawings, which form a part of the detailed description. The drawings show illustrations in accordance with exemplary aspects. These example aspects, which are also referred to herein as “examples,” are described in enough detail to enable those skilled in the art to practice the present subject matter.

The various aspects described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred aspect should not be limited by any of the above-described exemplary aspects.

While specific aspects of, and examples for, the system are described above for illustrative purposes, various equivalent modifications are possible within the scope of the system, as those skilled in the relevant art will recognize. For example, while processes or steps are presented in a given order, alternative aspects may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The aspects can be combined, other aspects can be utilized, or structural, logical, and electrical changes can be made without departing from the scope of what is claimed. It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. The detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.).

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,”, an embodiment”, “one embodiment”, “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary aspects were chosen and described to best explain the principles of the present technology and its practical application, and to enable others of ordinary skill in the art to understand the invention for various aspects with various modifications as are suited to the particular use contemplated.

1. A method to provide continuous and autonomous security protection from unauthorized access to privileged and sensitive system and user data in a runtime environment, the method comprising:
running, on a client device, a software development kit (SDK) in a first application sandbox with a first unique identifier (UID);
running, on a client device, an application comprising an SDK interface in a second application sandbox with a second UID; and
communicating between the application and the SDK via the SDK interface on a runtime service.

2. The method of claim 1, wherein the first UID and the second UID are associated with separate resources, wherein each of the separate resources includes at least one file, key, or registry.

3. The method of claim 1, further comprising:
preventing, by the first application sandbox, access to SDK resources contained in the first application sandbox by applications without the first UID; and
preventing, by the second application sandbox, access to application resources contained in the second application sandbox by applications without the second UID.

4. The method of claim 1, further comprising:
receiving, by the second application sandbox, an access request from the SDK, wherein the access request is transmitted by the SDK interface; and
permitting, by the second application sandbox, the SDK access to application resources associated with the second UID.

5. The method of claim 1, further comprising:
preventing, by an operating system, access to SDK resources associated with the first UID by requests without the first UID; and
preventing, by the operating system, access to application resources associated with the second UID by requests without the second UID.

6. The method of claim, 1 wherein the SDK provides at least one functionality for the application.

7. The method of claim 6, wherein the communicating between the application and the SDK comprises:
transmitting instructions from the application to the SDK to execute the at least one functionality.

8. The method of claim 1, further comprising:
executing the communicating between the application and the SDK by using at least one of a data blob exchange mechanism, a call back object, or an inter process communication call.

9. A method to secure a digital environment in a client device, the method comprising:
assigning, by the client device, a first unique identifier (UID) to a software development kit (SDK) newly installed from an SDK installation package;
assigning, by the client device, a second UID to an application newly installed on the client device from an application installation package, the application comprising an SDK interface;
executing the application newly installed on the client device; and
initiating the SDK interface in a common application sandbox containing the application newly installed on the client device and the SDK interface.

10. The method of claim 9, further comprising:
sending a request from the client device to an application distribution server, to download the application;
detecting a dependency between the application and the SDK installation package in the application distribution server;
downloading, into the client device, an application installation package associated with the application; and
downloading, into the client device, the detected SDK installation package without a separate request.

11. The method of claim 9, further comprising:
executing, on the client device, the SDK in an SDK sandbox; and
communicating between the SDK and the application via the SDK interface on a runtime service.

12. The method of claim 11, further comprising:
executing the communicating between the application and the SDK by using at least one of a data blob exchange mechanism, a call back object, or an inter process communication call.

13. The method of claim 11, further comprising:
preventing, by the SDK sandbox, access to SDK resources contained in the SDK sandbox by applications without the first UID; and
preventing, by the common application sandbox, access to application resources contained in the common application sandbox by applications without the second UID.

14. A client device for providing continuous and autonomous security protection from unauthorized access to privileged and sensitive data, the client device comprising:
a processor; and
a computer readable medium storing instructions executable by the processor to:
run, on a client device, a software development kit (SDK) in a first application sandbox with a first unique identifier (UID);
run, on the client device, an application comprising an SDK interface in a second application sandbox with a second UID; and
cause a communication between the application and the SDK by way of the SDK interface on a runtime service.

15. The client device of claim 14, wherein the first UID and the second UID are associated with separate resources, wherein each of the separate resources includes at least one file, key, or registry.

16. The client device of claim 14, wherein the instructions executable by the processor, further comprise:
prevent, by the first application sandbox, access to SDK resources contained in the first application sandbox by applications without the first UID; and
prevent, by the second application sandbox, access to application resources contained in the second application sandbox by applications without the second UID.

17. The client device of claim 14, wherein the instructions executable by the processor, further comprise:
receive, by the second application sandbox, an access request from the SDK, wherein the access request is transmitted by the SDK interface; and
permit, by the second application sandbox, the SDK access to application resources associated with the second UID.

18. The client device of claim 14, wherein the instructions executable by the processor, further comprise:
prevent, by an operating system, access to SDK resources associated with the first UID by requests without the first UID; and
prevent, by the operating system, access to SDK resources associated with the second UID by requests without the second UID.

19. The client device of claim 14, wherein the instructions to cause a communication, comprise:
transmit instructions from the application to the SDK to execute at least one functionality.

20. The client device of claim 14, wherein the instructions to cause a communication, comprise:
transmit instructions between the application and the SDK by using a data blob exchange mechanism, a call back object, or an inter process communication call.
